(19) United States
(12) Patent Application Publication
(10) Pub. No.: US 2001/0054068 A1
(43) Pub. Date: Dec. 20, 2001

(54) System and method for maintaining a web site

(75) Inventor: Paul E. Modiano, Brooklyn, NY (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: UpdateThis, Inc., New York, NY (US)

(21) Appl. No.: 09/880,531

(22) Filed: Jun. 13, 2001

Related U.S. Application Data
(60) Provisional application No. 60/213,222, filed on Jun. 14, 2000.

(51) Int. Cl. G06F 15/16

(52) U.S. Cl. 709/203

(57) ABSTRACT

A system and method for maintaining a web site including the steps of an apparatus for importing web pages of a web site to a staging server, formatting templates for the web pages, assigning content tags and data types to fields of the templates and designating users for the fields. The templates are populated with input received from users and the populated templates are exported to one or more web servers.

### CROSS-REFERENCE TO RELATED APPLICATIONS

This application claims the benefit of U.S. Provisional Patent Application No. 60/213,222, filed Jun. 14, 2000 entitled “System and Method for Maintaining a Web Site,” the contents of which are hereby incorporated by reference in its entirety.

### BACKGROUND OF THE INVENTION

The present invention relates to a system and method for maintaining a web site and more specifically to web content management.

### BRIEF DESCRIPTION OF THE SEVERAL VIEWS OF THE DRAWINGS

The foregoing, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a flow diagram illustrating one embodiment of the invention.

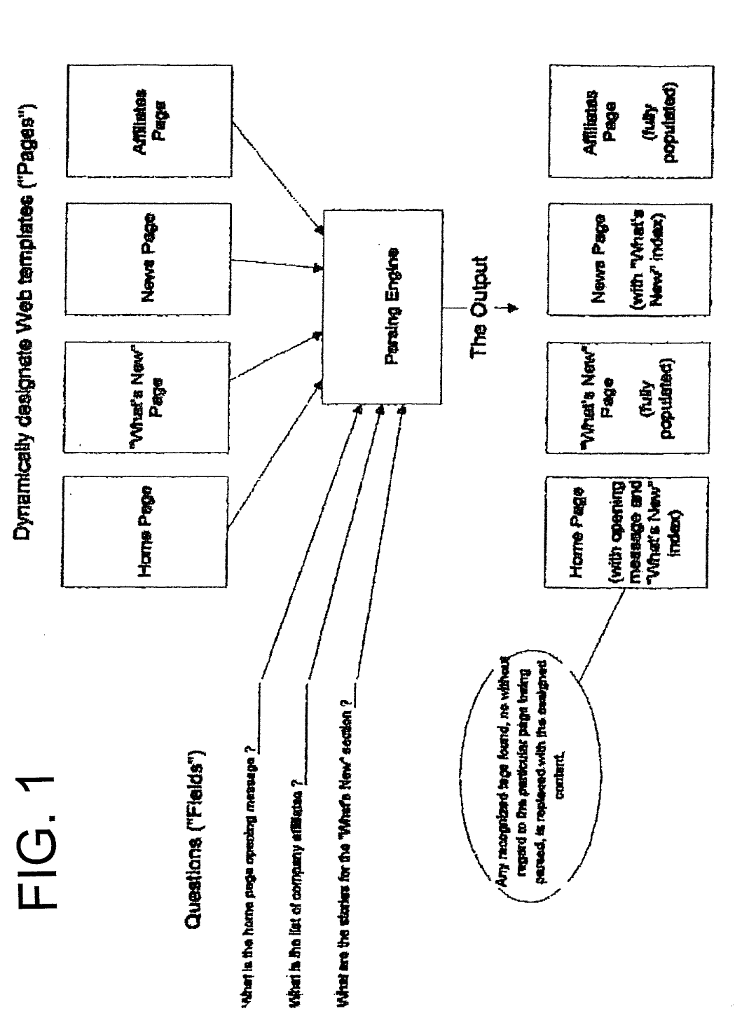

FIG. 2 is a flow diagram illustrating another embodiment of the invention.

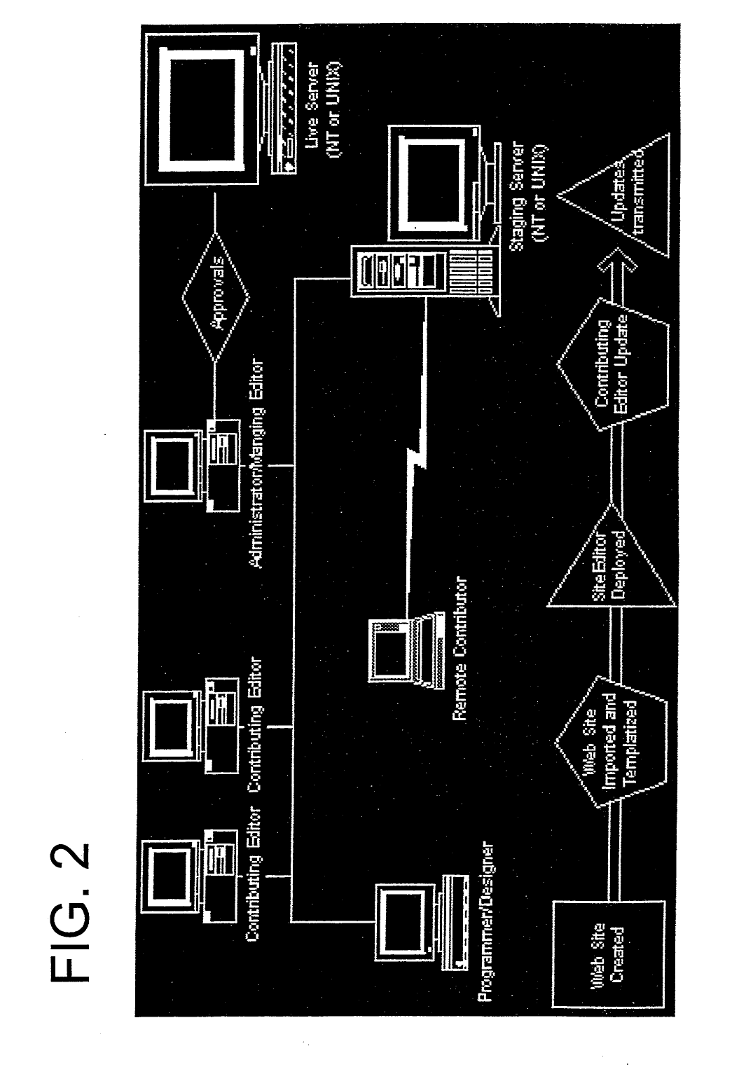

### DETAILED DESCRIPTION OF THE INVENTION

Web content management generally refers to editing and updating of material contained on a web site. Solutions exist which allow a user to manage the content of a web site. These solutions range from ground-up custom development using existing programming environments, to the manual updating of content.

Ground-up custom development of a content management solution with existing programming environments require the professional services of high-end web developers and often take several weeks to put in place, making implementation costs high. The result however, is that non-technical content contributors thereafter can update web site content at lower cost.

An organization which chooses not to implement a content management solution avoids initial costs, however, substantial costs will be incurred to employ a medium to high-end web developer(s) to perform the task of gathering disparate pieces of content from contributors and posting that content. As an organization's site grows, it can also quickly become unmanageable.

The system and method of the present invention allows a non-technical user to easily edit and update areas of content of a web site, and allows a moderately technical user to rapidly prepare content management solutions for use by non-technical content contributors. Additionally, content management development time and costs are reduced by an order of magnitude.

In one embodiment of the invention the system imports a number of web pages from an existing web site. The user/developer is prompted to indicate the web pages within a site which contain content elements which are to be made dynamic. The term dynamic, as used herein, generally refers to elements which can be edited and updated. The indicated web pages are used to create templates.

The developer is then prompted to provide one or more questions that will eventually be posed to a non-technical end user. For each question, the developer preferably provides the data type (text, list, link list, news list, anchor news list, graphic, etc.), the end user to whom that particular question will be posed, and the page which the end user will preview after the content is submitted. The list of questions (fields) serves as the end users' questions as well as the tags with which the developer will mark up the dynamically designated pages. This system requires a minimal number of definitions from the developer. By re-using the “field” name as both the end users' question and the content tag, the need for the developer to provide information and the chance of errors during those processes are diminished. The need for information from the developer regarding the location of the content tags disappears because of the process of replacing recognized tag(s) on the dynamically designated page(s).

The system preferably allows an authorized end user to log into the system. The end user is presented with the list of questions within his/her purview. The end user then selects a question and is presented with a web form in which the “answer” is placed. Upon submission of the answer by the end user, a parsing engine preferably populates the web templates by cycling through the dynamically designated page(s) and within each page, cycling through each field, replacing any recognized field with it's respective content. Upon completing the parsing, the end user is presented with the designated preview page(s), to allow the end user to view the page template (now populated with the user submitted content).

In another embodiment of the invention a method for maintaining a web site is provided comprising importing one or more web pages of a web site to a staging server, and formatting templates for one or more of the web pages from the web site. The templates include one or more fields. One or more content tags are assigned to one or more of the fields. One or more data types are also assigned to each of the fields. One or more users for each of the fields are designated. Input is received from one or more users. The templates are populated with the input from the one or more users, and the populated templates are exported to one or more web servers. The content tags preferably correspond to the questions posed to the users.

In another embodiment the invention is a system providing a platform for coordinating content updates made by nontechnical professionals. The system stages updates for preview and authorization, receives content feeds from third parties, sends content feeds to third parties (i.e. aggregators and distributors of online content), and publishers to any live web server on the Internet. The system is simple to configure and use.

In another embodiment of the invention, the system is designed to capture a site image on the staging server. The site image is captured by entering one or more optional parameters (i.e. how many levels to snake, megabyte limits etc.) and snaking a target site to create/capture the site image. One or more copies of the site image are stored on the staging server and can be used as the basis for the site templates to be created, and as the basis for the output or “staging” site. One or more databases are created on a database server, which are then populated with user data. A Data Source Name is then created on the web server which points to the one or more databases on the database server. The system then notifies the user/administrator/account manager that the web site/ project is ready to be templatized. The user/account manager can now quickly create a content management solution which can then be accessed by a site owner (i.e. for use as a personalized demonstration). The system and method of the present invention can be employed on an Intranet, Extranet or public Internet site, enabling an organization to employ a work flow management system that enables multiple contributors to define, create, and approve Web site content. The system allows everything from product descriptions, online inventory, shipping schedules, partner news, distributor locations, and customer data to be up-to-date and accurate. The system and method is designed to enable an organization to innovate, plan, develop, deploy, operate, and manage the effectiveness of a web site.

The system is preferably capable of drawing from and publishing to any type of web platform using FTP, NT, UNIX, LINUX, NEXT OS or the like. The system may also be designed to operate a subscription service.

The present invention may implemented with any combination of hardware and software. If implemented as a computer-implemented apparatus, the present invention is implemented using means for performing all of the steps and functions described above. The present invention can also be included in an article of manufacture (e.g., one or more computer program products) having, for instance, computer useable media. The media has embodied therein, for instance, computers readable program code means for providing and facilitating the mechanisms of the present invention. The article of manufacture can be included as part of a computer system or sold separately.

The invention is best understood from the above description when read in connection with the accompanying figures. Although the invention is described with reference to exemplary embodiments, it is not limited to those embodiments. Rather, the invention should be construed to include other variances and embodiments which may be made by those skilled in the art without departing from the spirit and scope of the present invention.

I claim:

1. A method of maintaining a web site, comprising:
importing one or more web pages of a web site to a staging server;
formatting templates for the web pages, the templates including one or more fields;
assigning one or more content tags to each of the fields;
assigning one or more data types to each of the fields;
designating one or more users for each of the fields;
receiving input from the users;
populating the templates with the received input; and
exporting the populated templates to one or more web servers.

2. The method of claim 1, wherein the web pages, the received input and the populated templates are transmitted over a public network.

3. The method of claim 1, wherein the content tags correspond to questions posed to the users.

4. The method of claim 1, wherein populating the templates includes cycling through each of the web pages and replacing one or more of the fields with the received input.

5. The method of claim 1, further comprising presenting the users with the populated templates.

6. The method of claim 1, further comprising posting the populated templates to the web site.

7. A method of updating a web site, comprising:
importing one or more web pages of a web site to a staging server;
formatting templates for one or more of the web pages;
prompting an end user to provide content for the web site;
populating the templates with the provided content;
providing the user with a preview of the populated templates;
exporting the populated templates to one or more web servers; and
posting the populated web pages to the web site.

8. A method of updating a web site, comprising:
importing a web site to a staging computer system;
processing the web site to produce one or more templates for each page of the web site;
receiving input from end users;
populating the templates with the received input;
exporting the populated templates to one or more web servers; and
posting the populated templates to the web site.

9. A web site management system, comprising:
means for importing one or more web pages of a web site to a staging server;
means for formatting templates for the web pages, the templates including one or more fields;
means for assigning one or more content tags to each of the fields;
means for assigning one or more data types to each of the fields;
means for designating one or more users for each of the fields;
means for receiving input from the users;
means for populating the templates with the received input; and
means for exporting the populated templates to one or more web servers.

10. The system of claim 9, wherein the web pages, the received input and the populated templates are transmitted over a public network.

11. The system of claim 9, wherein the content tags correspond to questions posed to the users.

12. The system of claim 9, wherein means for populating the templates includes means for cycling through each of the web pages and replacing one or more of the fields with the received input.

13. The system of claim 9, further comprising means for presenting the users with the populated templates.

14. The system of claim 9, further comprising means for posting the populated templates to the web site.

15. A web site management system for updating a web site, comprising:
means for importing one or more web pages of a web site to a staging server;
means for formatting templates for the web pages;
means for prompting an end user to provide content for the web site;
means for populating the templates with the provided content;
means for providing the user with a preview of the populated templates;
means for exporting the populated templates to one or more web servers; and
means for posting the populated web pages to the web site.

16. A web site management system for updating a web site, comprising:
means for importing a web site to a staging computer system;
means for processing the web site to produce one or more templates for each page of the web site;
means for receiving input from end users;
means for populating the templates with the received input;
means for exporting the populated templates to one or more web servers; and
means for posting the populated templates to the web site.

17. An article of manufacture for maintaining a web site, the article of manufacture comprising a computer-readable medium holding computer-executable instructions for performing a method comprising:
importing one or more web pages of a web site to a staging server;
formatting templates for one or more of the web pages, the templates including one or more fields;
assigning one or more content tags to one or more of the fields;
assigning one or more data types to one or more of the fields;
designating one or more users for one or more of the fields;
receiving input from the users;
populating the templates with the received input; and
exporting the populated templates to one or more web servers.

18. The article of manufacture of claim 17, wherein the web pages, the received input and the populated templates are transmitted over a public network.

19. The article of manufacture of claim 17, wherein the content tags correspond to questions posed to the users.

20. The article of manufacture of claim 17, wherein populating the templates includes cycling through each of the web pages and replacing one or more of the fields with the received input.

21. The article of manufacture of claim 17, wherein the computer-executable instructions perform a method further comprising presenting the users with the populated templates.

22. The article of manufacture of claim 17, wherein the computer-executable instructions perform a method further comprising posting the populated templates to the web site.

23. An article of manufacture for updating a web site, the article of manufacture comprising a computer-readable medium holding computer-executable instructions for performing a method comprising:
importing one or more web pages of a web site to a staging server;
formatting templates for the web pages;
prompting an end user to provide content for the web site;
populating the templates with the provided content;
providing the user with a preview of the populated templates;
exporting the populated templates to one or more web servers; and
posting the populated web pages to the web site.

24. An article of manufacture for updating a web site, the article of manufacture comprising a computer-readable medium holding computer-executable instructions for performing a method comprising:
importing a web site to a staging computer system;
processing the web site to produce one or more templates for each page of the web site;
receiving input from end users;
populating the templates with the received input;
exporting the populated templates to one or more web servers; and
posting the populated templates to the web site.
